(19) United States
(12) Patent Application Publication
(10) Pub. No.: US 2022/0036273 A1
(43) Pub. Date: Feb. 3, 2022

(54) WEB-BASED DIGITAL THREAD DRIVEN SUSTAINABLE MANUFACTURING VIA DIGITALLY-INTEGRATED, MULTI-LIFECYCLE PRODUCT DEVELOPMENT

(71) Applicants: Siemens Corporation, Iselin, NJ (US); The University of Kentucky Research Foundation, Lexington, KY (US)

(72) Inventors: Dmitriy Okunev, Lawrenceville, NJ (US); Sanjeev Srivastava, Princeton Junction, NJ (US); Fathima Badurdeen, Lexington, KY (US)

(21) Appl. No.: 17/414,074

(22) PCT Filed: Jan. 6, 2020
(86) PCT No.: PCT/US2020/012315

§ 371 Date: Jun. 15, 2021

Related U.S. Application Data
(60) Provisional application No. 62/790,053, filed on Jan. 9, 2019.

(51) Int. Cl. G06Q 10/06; G06Q 10/10; G06Q 50/04

(52) U.S. Cl. CPC G06Q 10/06375; G06Q 50/04; G06Q 10/10

(57) ABSTRACT

A system and a method that enable a digital thread-driven sustainability design wherein a Digital Thread (DT) is proposed as a distributed enterprise software platform that is designed for managing lifecycle sustainability data of a product throughout its lifecycle. A digitally integrated total lifecycle product design using a Digital Thread model is provided that enables one to perform predictive computational modeling for multi-lifecycle product design. The Digital Thread enables a set of predictive computational modeling tools for total lifecycle product design optimization, simulation and uncertainty and risk analysis integrated to access data through the Digital Thread. A systematic approach for development and analysis of a lifecycle sustainability model of a designed product is provided. Also, a central repository concept or a single point of access to the lifecycle sustainability data is provided.

### CROSS REFERENCE TO RELATED APPLICATIONS

This application claims the benefit of U.S. Provisional Application Ser. No. 62/790,053 entitled “DIGITAL THREAD-DRIVEN SUSTAINABILITY DESIGN,” filed on Jan. 9, 2019, the contents of which are hereby incorporated by reference herein in their entirety.

### BACKGROUND

### 1. Field

Aspects of the present invention generally relate to a system and a method that enable a digital thread-driven sustainability design wherein a Digital Thread (DT) is proposed as a distributed enterprise software platform that is designed for managing lifecycle sustainability data of a product throughout its lifecycle.

### 2. Description of the Related Art

With increasing global awareness on the importance of environmental protection and stricter enforcement of environmental regulations, the application of product recovery, reuse, remanufacturing, and recycling strategies after product use has become more widespread. Implementing such end-of-life (EoL) strategies during sustainable product design can help companies mitigate environmental impacts and conform to strict regulations, increase global manufacturing competitiveness, reduce the cost of manufacturing and disposal, and promote sustainable economic growth.

Contrary to open-loop product lifecycle systems where products are disposed at the end of their useful life, closed-loop systems require companies to make commitments for taking care of the entire product lifecycle. Such systems aim to minimize new material and energy resources entering the system, maximizing the efficiency and usage life of materials and components, and eliminating wastes and emissions by adopting product EoL recovery strategies. A closed-loop supply chain involves collecting used products from customers and performing product recovery strategies, such as reuse, remanufacturing, and recycling as well as disposing unrecoverable components/materials safely. In closed-loop systems, products, components and materials can be utilized multiple times over multiple lifecycles before landfilled. However, recycled materials are commonly used in different applications that leads to a challenge to close the loop in industrial practices.

Product design and manufacturing involve critical decisions, such as determining the type of materials and components to be used, manufacturing operations to be applied, energy and resources consumption, as well as byproducts, and product EoL treatment, all of which will have considerable impact on total product lifecycle sustainability. Recently, there has been a growing focus on sustainable product design with an emphasis on the entire lifecycle. The 6R (Reduce, Reuse, Recycle, Redesign, Recover and Remanufacture) approach has been adopted to enhance total lifecycle sustainability in product design and manufacturing processes. It involves reducing resource consumption and waste generated, reusing products and components, recycling materials, collecting back and recovering products after EoL, redesigning products to improve the ease of EoL treatment, and remanufacturing used products to restore their function and aesthetic appearance to like-new condition. The 6R approach helps enabling a closed-loop material flow where the maximum utility can be gained from the materials, components, and the energy consumed while reducing overall economic, environmental, and societal impacts of products. Therefore, implementing the 6R approach in product design and manufacturing practices promotes sustainability of product development. An approach is presented for identifying influencing factors to evaluate sustainability and optimization models at the product, process and system levels. An overall product sustainability index (ProdSI) is also proposed to evaluate total lifecycle sustainability of products considering individual economic, environmental and societal metrics, in which expert judgments and normalization were utilized to estimate sustainability performance. ProdSI covers all lifecycle stages from pre-manufacturing, manufacturing, use, to post-use.

Considering the implementation of EoL strategies across multiple lifecycles of a product will enable maximum recovery of the materials and embedded energy from previous lifecycle products for use in subsequent lifecycle products. Such practices can help companies increase global manufacturing competitiveness and promote corporate social responsibility for more sustainable economic growth. However, a multi-lifecycle-based approach to product configuration design optimization, simultaneously considering conflicting objectives, has not been well addressed to respond the global challenges and needs of companies. Further, highly variable EoL product returns and other uncertainties across the supply chain can impact the economic (i.e., total cost) and environmental (i.e., global warming potential, water use and energy use) performance of chosen product configuration design. Most risk analysis methods used during product design are qualitative in nature, making them unsuitable to fully capture the interdependencies between risk events not providing product designers with sufficient insight to identify the most suitable product configurations.

Identifying the most suited product configuration design is a critical decision for any OEM. It is a strategic decision that can influence corporate profitability and sustainability over multiple years when the product is in market. Decision support tools are an important resource for product designers and design engineers when identifying the most suited design. Many limitations affect the ability of product designers and design engineer's ability to identify optimal product configurations that enhance total lifecycle sustainability performance:

a) Current product data management tools generally do not consider multi-criteria decision making for sustainable product design and analysis.

b) Existing predictive models have not well addressed multi-lifecycle approach for sustainable product design and analysis.

Therefore, there is a need of better sustainability design in product design and manufacturing.

### SUMMARY

Briefly described, aspects of the present invention relate to a digitally integrated total lifecycle product design using a Digital Thread model that enables one to perform predictive computational modeling for total lifecycle product design. An integrated software platform linked through a ‘digital thread’ is provided to develop a digitally integrated total lifecycle product design model and to perform validation of the model. This ‘digital thread’ enabled platform can support and provide data to a set of predictive computational modeling tools for total lifecycle product design optimization, simulation and uncertainty and risk analysis integrated. Application of the digitally integrated modeling tools to perform multi-lifecycle-based product configuration design optimization is provided. Embodiments provide a comprehensive interoperable digital thread that can be used to integrate data sources from all product lifecycle stages, to provide the information required to support product design decisions for multi-lifecycle sustainable product development. The digitally-enabled decision support tools can address the abovementioned problems through: (1) a ‘digital thread’ linking the data across various lifecycle stages and multi-lifecycle, (2) an integrated software platform linked through a ‘digital thread’, (3) an optimization model that considers multi-lifecycle material flow across the entire demand cycle for sustainable product configuration design, and (4) simulation for multi-lifecycle performance assessment to quantify the impact of design parameter variability on key performance metrics (KPIs) related to economic and environmental performance for a given product configuration design. The integrated, digital thread and decision support tools were validated by application of a laser toner cartridge configuration design. The findings show that the optimization model yields optimal design alternatives that offer lower total lifecycle cost and better environmental performance compared to conventional baseline designs. The digital thread driven tools can be customized for different use cases/applications to consider one or many EoU/EoL strategies and assess potential impacts.

In accordance with one illustrative embodiment of the present invention, a computer-implemented method for sustainable manufacturing via digitally-integrated, multi-lifecycle product development is provided. The method comprises using a plurality of product lifecycle models to select an optimal design for a product, each product lifecycle model corresponding to one of a plurality of product lifecycle stages. The method further comprises collecting from at least one of the plurality of product lifecycle stages lifecycle sustainability data using a web-based digital thread which provides semantic linking to data residing in discrete repositories and files. The method further comprises providing a suite of decision support tools that support seamless digital integration in the plurality of product lifecycle stages of one product lifecycle. The method further comprises enabling access to data necessary for the suite of decision support tools using the web-based digital thread. The method further comprises feeding into the suite of decision support tools the data accessed through the web-based digital thread to conduct optimization and analysis. The method further comprises feeding back an output from the suite of decision support tools through the web-based digital thread to identify a product configuration design that will satisfy original equipment manufacturer (OEM) objectives. The method further comprises adopting a multi-lifecycle closed-loop material flow strategy for the product configuration design in that end-of-life (EOL) products, components or materials recovered from the one product lifecycle are to be channeled into products in subsequent product lifecycles.

In accordance with another illustrative embodiment of the present invention, a data processing system is provided for generating an optimal design of a product based on a data-feedback loop from the product lifecycle into design and manufacturing information. The system comprises a software interface configured to receive measured product lifecycle datasets uploaded by one or more stakeholders during each of a plurality of product lifecycle stages. The system further comprises a database configured to store the measured product lifecycle datasets uploaded via the software interface. The system further comprises one or more processors. The system further comprises an accessible memory for storing a digitally integrated total lifecycle product designer comprising software instructions that when executed by the one or more processors are configured to use a plurality of product lifecycle models to select an optimal design for a product, each product lifecycle model corresponding to one of the plurality of product lifecycle stages. The software instructions that when executed by the one or more processors are configured to collect from at least one of the plurality of product lifecycle stages lifecycle sustainability data using a web-based digital thread which provides semantic linking to data residing in discrete repositories and files and provide a suite of decision support tools that support seamless digital integration in the plurality of product lifecycle stages of one product lifecycle. The software instructions that when executed by the one or more processors are configured to enable access to data necessary for the suite of decision support tools using the web-based digital thread, feed into the suite of decision support tools the data accessed through the web-based digital thread to conduct optimization and analysis and feedback an output from the suite of decision support tools through the web-based digital thread to identify a product configuration design that will satisfy original equipment manufacturer (OEM) objectives. The software instructions that when executed by the one or more processors are configured to adopt a multi-lifecycle closed-loop material flow strategy for the product configuration design in that end-of-life (EOL) products, components or materials recovered from the one product lifecycle are to be channeled into products in subsequent product lifecycles.

In accordance with another illustrative embodiment of the present invention, a non-transitory computer-readable medium encoded with executable instructions is provided. Instructions, when executed, cause one or more data processing systems to: use a plurality of product lifecycle models to select an optimal design for a product, each product lifecycle model corresponding to one of the plurality of product lifecycle stages; collect from at least one of the plurality of product lifecycle stages lifecycle sustainability data using a web-based digital thread which provides semantic linking to data residing in discrete repositories and files; provide a suite of decision support tools that support seamless digital integration in the plurality of product lifecycle stages of one product lifecycle; enable access to data necessary for the suite of decision support tools using the web-based digital thread; feed into the suite of decision support tools the data accessed through the web-based digital thread to conduct optimization and analysis; feedback an output from the suite of decision support tools through the web-based digital thread to identify a product configuration design that will satisfy original equipment manufacturer (OEM) objectives; and adopt a multi-lifecycle closed-loop material flow strategy for the product configuration design in that end-of-life (EOL) products, components or materials recovered from the one product lifecycle are to be channeled into products in subsequent product lifecycles.

### BRIEF DESCRIPTION OF THE DRAWINGS

FIG. 1 illustrates a block diagram of a data processing system that enables a digital thread-driven sustainability design in accordance with an exemplary embodiment of the present invention.

FIG. 2 illustrates a block diagram of a framework for digitally-integrated, multi-lifecycle product development decision support tools in accordance with an exemplary embodiment of the present invention.

FIG. 3 illustrates a total lifecycle-based closed-loop material flow system in accordance with an exemplary embodiment of the present invention.

FIG. 4 illustrates component flows across multiple lifecycles in accordance with an exemplary embodiment of the present invention.

FIG. 5 illustrates an approach for multiple lifecycle-based product configuration design in accordance with an exemplary embodiment of the present invention.

FIG. 6 illustrates a Digital Thread operating model in accordance with an exemplary embodiment of the present invention.

FIG. 7 illustrates a Digital Thread Framework in accordance with an exemplary embodiment of the present invention.

FIG. 8 illustrates lifecycle sustainability data schema in accordance with an exemplary embodiment of the present invention.

FIG. 9 illustrates a schematic view of a flow chart of a method for sustainable manufacturing via digitally-integrated, multi-lifecycle product development in accordance with an exemplary embodiment of the present invention.

FIG. 10 shows an example of a computing environment within which embodiments of the disclosure may be implemented.

### DETAILED DESCRIPTION

To facilitate an understanding of embodiments, principles, and features of the present invention, they are explained hereinafter with reference to implementation in illustrative embodiments. In particular, they are described in the context of a system and a method that provide capabilities for a digitally interfacing system across the product lifecycle to provide access to requisite information required by integrated modeling tools for predictive modeling-based decision support. The present invention leveraged existing software platforms for product design, Life Cycle Assessment (LCA) input as well as sustainability assessment tools to develop a digital thread-enabled modeling capability. A laser toner cartridge configuration testbed is used to demonstrate the business benefits of the digital thread via the use of decision support tools developed, and how the tools help minimize total lifecycle costs, energy use, global warming potential (GWP), and water use enable better sustainability and better multi-lifecycle performance. Embodiments of the present invention, however, are not limited to use in the described devices or methods.

The components and materials described hereinafter as making up the various embodiments are intended to be illustrative and not restrictive. Many suitable components and materials that would perform the same or a similar function as the materials described herein are intended to be embraced within the scope of embodiments of the present invention.

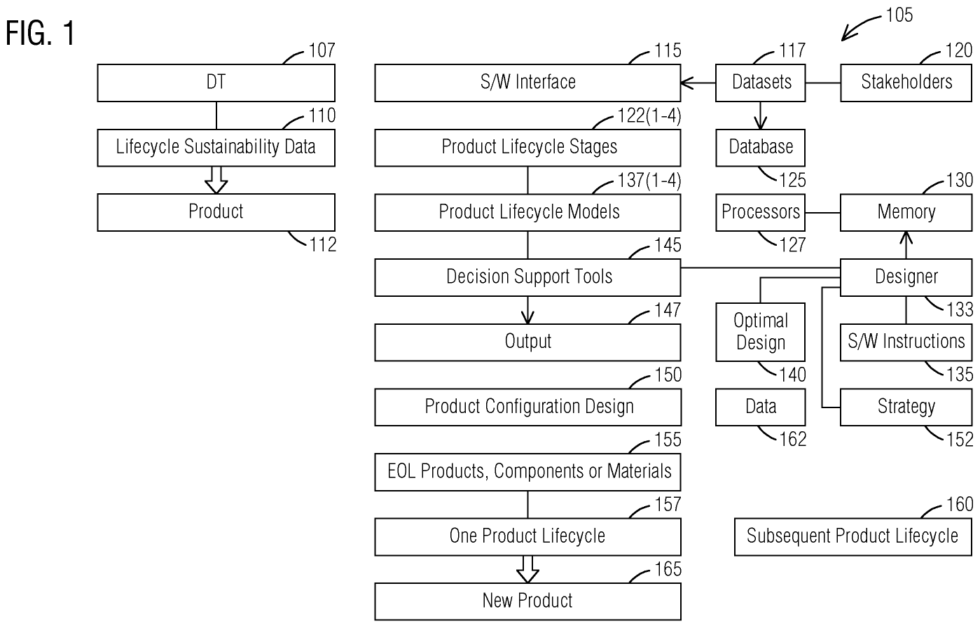

These and other embodiments of an automation system according to the present disclosure are described below with reference to FIGS. 1-10 herein. Like reference numerals used in the drawings identify similar or identical elements throughout the several views. The drawings are not necessarily drawn to scale.

Consistent with one embodiment of the present invention, FIG. 1 represents a block diagram of a data processing system 105 that enables a digital thread-driven sustainability design wherein a web-based Digital Thread (DT) 107 is proposed as a distributed enterprise software platform that is designed for managing lifecycle sustainability data 110 of a product 112 throughout its lifecycle in accordance with an exemplary embodiment of the present invention. The data processing system 105 is configured to generate an optimal design of the product 112 based on a data-feedback loop from product lifecycle into design and manufacturing information.

The data processing system 105 comprises a software interface 115 configured to receive measured product lifecycle datasets 117 uploaded by one or more stakeholders 120 during each of a plurality of product lifecycle stages 122(1-4). The data processing system 105 further comprises a database 125 configured to store the measured product lifecycle datasets 117 uploaded via the software interface 115. The software interface 115 is further configured to facilitate downloading of the measured product lifecycle datasets 117 stored in the database 125 by the one or more stakeholders 120. The data processing system 105 further comprises one or more processors 127. The data processing system 105 further comprises an accessible memory 130 storing a digitally integrated total lifecycle product designer 133 comprising software instructions 135 that when executed by the one or more processors 127 are configured to use a plurality of product lifecycle models 137(1-4) to select an optimal design 140 for the product 112, each product lifecycle model 137 corresponding to one of the plurality of product lifecycle stages 122.

In operation, the digitally integrated total lifecycle product designer 133 is configured to collect from at least one of the plurality of product lifecycle stages 122(1-4) the lifecycle sustainability data 110 using the web-based Digital Thread (DT) 107 which provides semantic linking to data residing in discrete repositories and files. The digitally integrated total lifecycle product designer 133 is configured to provide a suite of decision support tools 145 that support seamless digital integration in the plurality of product lifecycle stages 122(1-4) of one product lifecycle. The digitally integrated total lifecycle product designer 133 is configured to enable access to data necessary for the suite of decision support tools 145 using the web-based Digital Thread (DT) 107. The digitally integrated total lifecycle product designer 133 is configured to feed into the suite of decision support tools 145 the data accessed through the web-based Digital Thread (DT) 107 to conduct optimization and analysis.

The digitally integrated total lifecycle product designer 133 is further configured to feedback an output 147 from the suite of decision support tools 145 through the web-based Digital Thread (DT) 107 to identify a product configuration design 150 that will satisfy original equipment manufacturer (OEM) objectives. The feeding back of the output 147 from the suite of decision support tools 145 through the web-based Digital Thread (DT) 107 further comprises considering activities across all four product lifecycle stages 122 of the plurality of product lifecycle stages 122(1-4) and data 162 for all economic, environmental and societal impacts related to the four product lifecycle stages 122(1-4). Considering activities across all four product lifecycle stages 122 of the plurality of product lifecycle stages 122(1-4) further comprises considering sourcing materials to converting them to finished products as well as their consumption and end-of-life (EOL) activities.

The digitally integrated total lifecycle product designer 133 is further configured to adopt a multi-lifecycle closed-loop material flow strategy 152 for the product configuration design 150 in that end-of-life (EOL) products, components or materials 155 recovered from one product lifecycle 157 are to be channeled into products in subsequent product lifecycles 160. Adopting the multi-lifecycle closed-loop material flow strategy 157 for the product configuration design 150 further comprises considering all four product lifecycle stages 122 of the plurality of product lifecycle stages 122(1-4) over the duration a new product 165 will be in market.

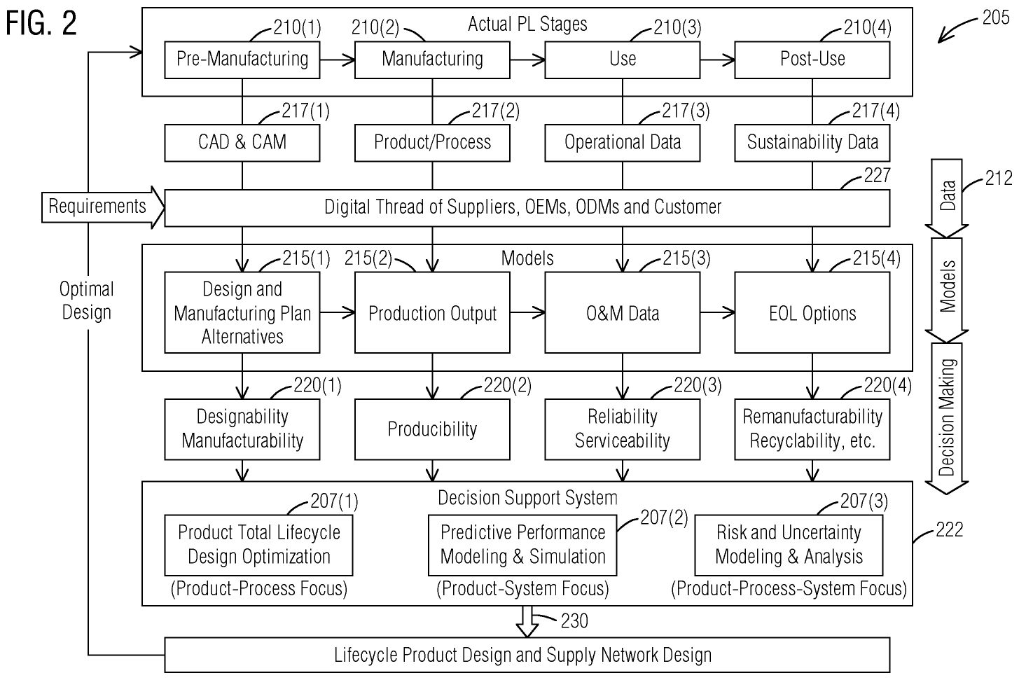

Referring to FIG. 2, it illustrates a block diagram of a framework 205 for a plurality of digitally-integrated, multi-lifecycle product development decision support tools 207(1-3) in accordance with an exemplary embodiment of the present invention. Referring to FIGS. 1 and 2, to assist product developers in identifying the most desired product configuration, the decision support tools 207(1-3) incorporate a holistic approach covering a multitude of aspects. The variety of aspects considered and the approach to their digital integration is illustrated in FIG. 2. As shown, the framework 205 considers activities across all four product lifecycle stages 210(1-4) and data 212 for all economic, environmental and societal impacts (depending on data availability) related to these stages from sourcing materials to converting them to finished products as well as their consumption and EOL activities. When the multi-lifecycle closed-loop material flow strategy 152 is adopted, the EOL products/components/materials recovered from the one product lifecycle 157 must be channeled into products in the subsequent product lifecycles 160. To account for this aspect, all lifecycles over the duration of the new product 165 that will be in the market are also considered.

The four product lifecycle (PL) stages 210(1-4) include a pre-manufacturing PL stage 210(1), a manufacturing PL stage 210(2), a use PL stage 210(3), and a post-use PL stage 210(4). As shown, the framework 205 includes four models 215(1-4) including a design and manufacturing plan alternatives model 215(1), a production output model 215(2), an O&M data model 215(3), and an EOL options model 215(4).

From the pre-manufacturing PL stage 210(1) CAD and CAM data 217(1) is input into the design and manufacturing plan alternatives model 215(1). From the manufacturing PL stage 210(2) product and process data 217(2) is input into the production output model 215(2). From the use PL stage 210(3) operational data 217(3) is input into the O&M data model 215(3). From the post-use PL stage 210(4) sustainability data 217(4) is input into the EOL options model 215(4).

The design and manufacturing plan alternatives model 215(1) provide designability and manufacturability input 220(1) to a decision support system 222 including the decision support tools 207(1-3). The production output model 215(2) provides producibility input 220(2) to the decision support system 222. The O&M data model 215(3) provides reliability and serviceability input 220(3) to the decision support system 222. The EOL options model 215(4) provides remanufacturability and recyclability input 220(4) to the decision support system 222.

The decision support tools 207(1-3) can include a product multi-lifecycle design optimization tool 207(1), a performance modeling and simulation tool 207(2), and a risk and uncertainty modeling and analysis tool 207(3).

Data 212 related to different product lifecycle stages 210(1-4) was stored in different repositories of the OEM and some information may also have resided with suppliers, potential customers and other stakeholders. In one embodiment, a web-based Digital Thread (DT) 227 integrating the data repositories of the OEM, relevant suppliers and other stakeholders is developed to access all information necessary for the decision support tools 207(1-3). Data accessed through the digital thread 227 is then fed into the suite of decision support tools 207(1-3) to conduct optimization and other analyses. An output 230 from the decision support tools 207(1-3) is then fed back through the digital thread 227 to product development engineers and other decision makers to help identify the most suitable product configuration design that will satisfy OEM objectives.

FIG. 2 illustrates the framework 205 for incorporating a data-feedback loop from product lifecycle into design and manufacturing, according to some embodiments. The framework 205 includes the various PL stages 210(1-4) associated with the product 112. Here, there are four PL stages 210(1-4) illustrated. It should be noted that the number and type of PL stages is product dependent. Thus, additional PL stages may be included in the framework 205 based on the specifics of each product. For example, the Manufacturing PL stage 210(2) may be decomposed into PL stages for different types of manufacturing (e.g., non-additive and additive). Additionally, the framework 205 for some products may include less PL stages 210. For example, for a software product, the Recycle/Disposal PL stage may not be relevant.

Each PL stage 210 in the framework 205 operates relatively independently (although some of the PL stages may be performed in the same physical location). Each PL stage 210 outputs information, which is used by subsequent stages during the lifecycle. Thus, during a first PL stage, a computer aided design (CAD) model may be created which has specifications on the product design. Based on this CAD model, the next PL stage develops Computer-aided manufacturing (CAM) information specifying data needed to drive the manufacturing process (e.g., machines to utilize, input data for each machine, etc.). Once the product 112 reaches the end-of-life, it enters the post-use PL stage 210(4) where information may be collected involved such as, for example, disposal or recycling costs, environmental impact, etc.

The web-based digital thread 227 is used to collect all the information generated during the PL stages shown in the framework 205. The term “digital thread,” as used herein refers to a cross-domain, digital surrogate of the product lifecycle which aggregates information from the various PL stages. The web-based digital thread 227 resides on one or more server computers (see, e.g., FIG. 9) which are accessible over the internet via one or more network interfaces.

As shown in FIG. 2, the web-based digital thread 227 receives data (e.g., bill of materials, cost, pricing, service data, shipping data, etc.) from various actual PL stages 210, uploaded by different stakeholders (e.g., suppliers, Original Equipment Manufacturers, Original Design Manufacturers, the customer). The web-based digital thread 227 is responsible of providing a software interface for data upload, download (between digital model and actual operations) and exchange (between different PL stages) inside the web-based digital thread 227. Various techniques may be used for implementing the software interface of the web-based digital thread 227. The software interface may be implemented using well-known web standards to allow direct use by the stakeholders. In some embodiments, the software interfaces adhere to Representational State Transfer (REST) architectural constraints. For example, in some embodiments, the web server(s) running the digital thread 227 may be accessed by appending one or more commands to a base URL such as http://<runtime_host>/digital_thread/,” where “runtime_host” is the server that is running the digital thread. Thus, to continue with this example, a manufacturing computer may transmit data to the web server(s) using an HTTP PUT or POST command and the URL “http ://<runtime_host>/digital thread/manufacturing/update.” Similarly, in some embodiments, the REST interface may be extended to allow queries to the web-based digital thread 227 using an HTTP GET command and a particular URL (e.g., “http://runtime_host>/digital_thread/manufacturing/data”). It should be noted that the REST interface is only one example of the how the software interface may be implemented. In other embodiments, different web-based interface techniques may be used.

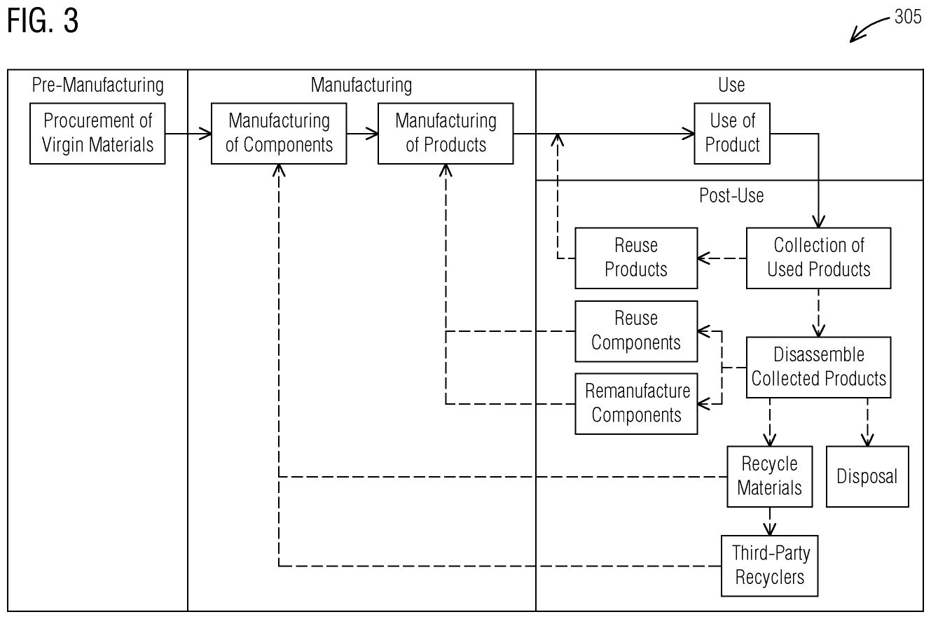

Turning now to FIG. 3, which illustrates a total lifecycle-based closed-loop material flow system 305 in accordance with an exemplary embodiment of the present invention. Sustainable product design requires being responsible for the products' entire life from extracting materials to disposal of retired products. A closed-loop material flow system considers the total product lifecycle that includes the pre-manufacturing, manufacturing, use, and post-use stages. FIG. 3 shows the total lifecycle-based closed-loop material flow system 305 considered in the present invention. The straight-line and dashed-line arrows indicate the forward and reverse flow of the supply chain, respectively. After products are used, they can be collected and recovered through further post-use activities (reuse, remanufacturing and recycling). Some companies may reuse EoL products after the first life; however, component reuse and remanufacturing is more common and are considered here. Components that are not reused or remanufactured can be recycled for material recovery or sold to third-party recyclers to gain revenue and reduce the overall environmental impact. In addition, at the end of each lifecycle, there could be some components and materials that may have to be disposed.

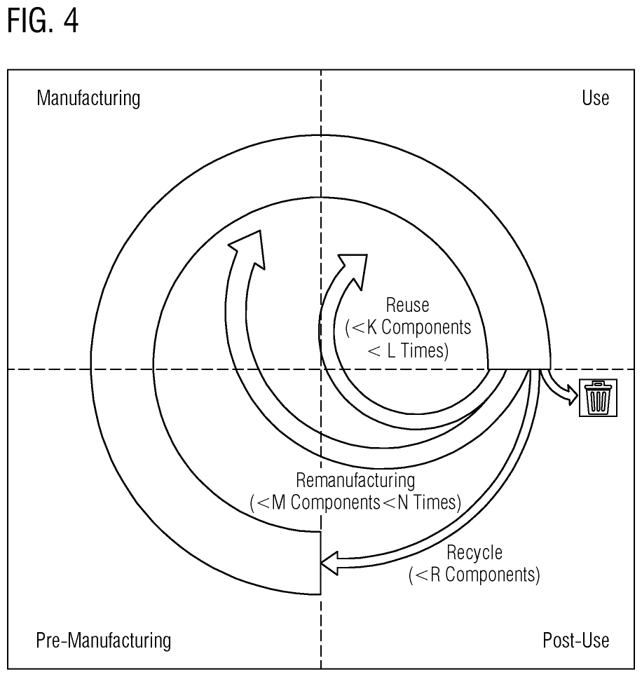

FIG. 4 illustrates component flows across multiple lifecycles in accordance with an exemplary embodiment of the present invention. In order to enable closed-loop material flow, the EoL strategies must be considered during the design process to achieve a sustainable product design. Therefore, determining (optimal) product design features is essential to enable multi-lifecycle material flow throughout the duration a product is in market. FIG. 4 represents the potential paths of flow of a product and its components when multiple lifecycles are considered. As illustrated, components of a product may be reused and/or remanufactured a number of times (say, at most K components reused for no more than L times and at most M components remanufactured for no more than N times) based on material type and quality. Components that are no longer reused or remanufactured (R components) can be recycled for material recovery or disposed.

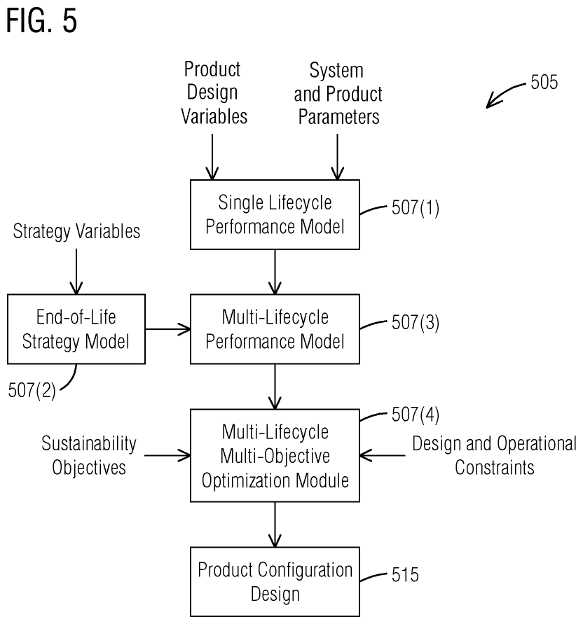

As seen in FIG. 5, it illustrates an approach 505 for multiple lifecycle-based product configuration design 515 in accordance with an exemplary embodiment of the present invention. The approach 505 is used to determine the optimal product configuration (i.e., component selection) considering the multi-lifecycle approach with respect to economic and environmental objectives. The approach 505 for multiple lifecycle-based product configuration design includes use of a Single Lifecycle Performance Model 507(1), an End-of-life Strategy Model 507(2), a Multi-lifecycle Performance Model 507(3), and a Multi-lifecycle Multi-objective Optimization Module 507(4).

The Single Lifecycle Performance Model 507(1) is a mathematical or simulation model of the product and/or the system through which various key performance measures for the product can be computed for a single lifecycle, given values of product design variables and various system and product parameters. These performance measures will be based on how the product operates in the system or how it is used by the user. Examples of these measures are—lifecycle cost, efficiency, mechanical health, etc.

The End-of-life Strategy Model 507(2) is a mathematical or simulation model of possible end-of-life (EOL) scenario(s) for a given product. Any EOL scenario will consist of a certain cost, depending on choice of EOL strategy selected by the user, such as reuse, recycle, etc. EOL strategy will affect the quality of product's sub-components, there reuse and hence product's performance in subsequent lifecycles.

The Multi-lifecycle Performance Model 507(3) is a mathematical or simulation model through which key performance measures of a product can be computed over multiple lifecycles. It takes outputs of EOL strategy model and single lifecycle performance model to compute multi-lifecycle performance measures.

The Multi-lifecycle Multi-objective Optimization Module 507(4) contains a multi-objective optimization solver that can compute optimal product design variables that maximizes or minimizes sustainability objectives defined by the user. The user also provided a set of design and operational constraints for the product.

Sustainable manufacturing is essentially a complex systems problem since to achieve it, it must strive for a holistic approach that differs from traditional manufacturing practices where most key performance indicators (KPI's) are measured and quantified independently, often with no consideration of the other integral elements. A successful demonstration of this holistic approach requires a suite of tools that support seamless digital integration in various stages of the product lifecycle, to improve sustainability performance, productivity and data exchange efficiency.

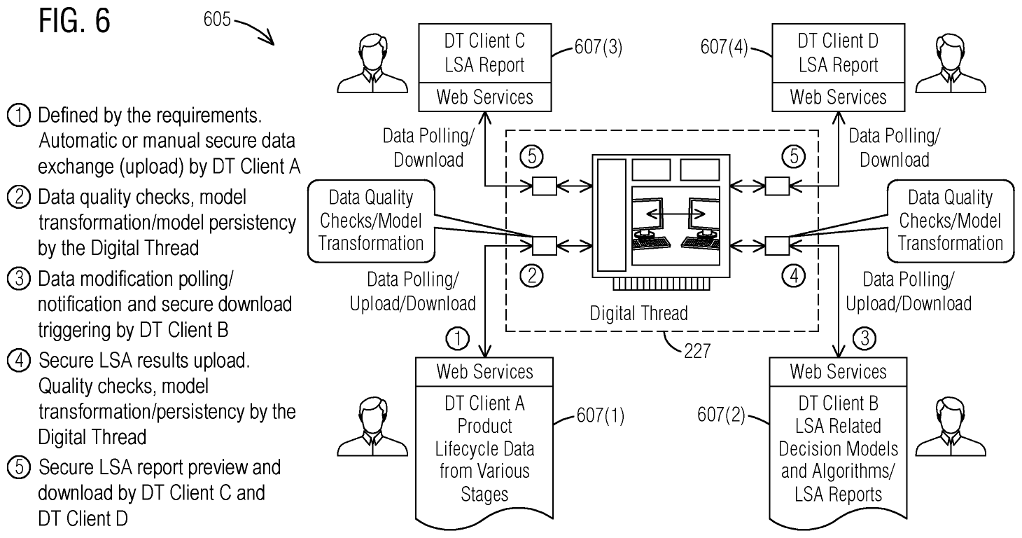

As shown in FIG. 6, it illustrates a Digital Thread (DT) operating model 605 in accordance with an exemplary embodiment of the present invention. The Digital Thread operating model 605 depicts operational scenarios of the web-based digital thread 227 for the product's sustainability. The web-based digital thread 227 maintains and communicates a complete, multi-faceted, multi-disciplinary Lifecycle Sustainability Analysis (LSA) model of the product 112 in various levels of product lifecycle. The Digital Thread operating model 605 depicts multiple DT users with different roles. For example, a user A 607(1) is uploads lifecycle data to the web-based digital thread 227 from different sources. As soon as this data is validated and successfully persisted in a DT portal (a web server) other DT users are notified that new sustainability data is available.

In the Digital Thread operating model 605, a user B 607(2) is responsible for developing LSA—related decision models and downloading the data from the web-based digital thread 227 to its local DT client. After running data analysis and updating models with analysis results, the user B 607(2) uploads results back to the web-based digital thread 227, providing additional data for a global product sustainability model. Finally, when the model reaches its maturity, users C and D 607(3-4) (plant managers, product managers etc.) download full LSA report and make decisions on future products, and its LSA aspects based on the current LSA information from the report(s). In summary, this scenario describes the concept of real-life application of the web-based digital thread 227 in the context of the product sustainability. The Digital Thread operating model 605 has ability to conduct LSA data management and exchange by means of semantically linking data from different sources, sites and domains via a DT client-server interface.

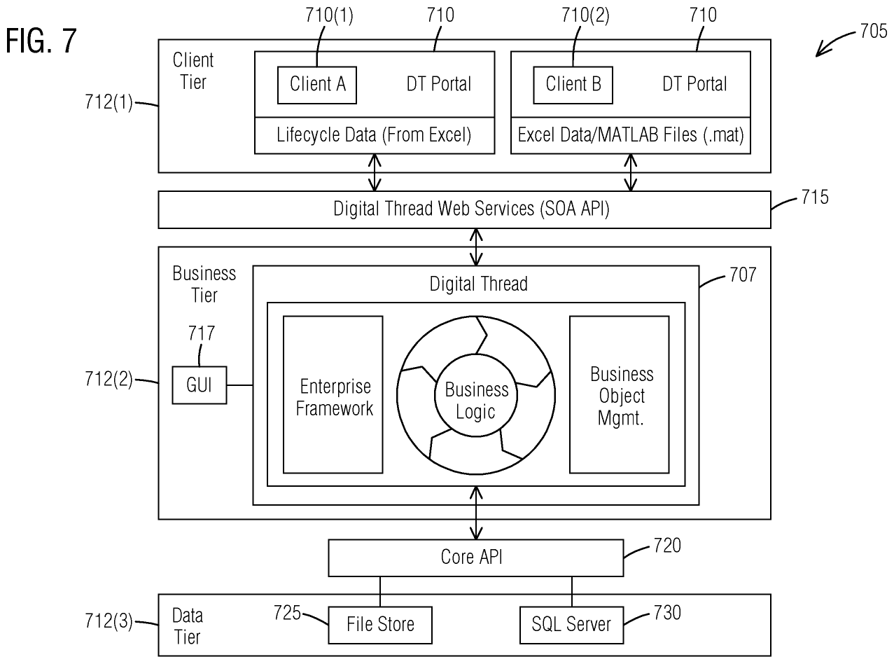

The web-based digital thread 227 is proposed as a distributed enterprise software platform that is designed for managing the lifecycle sustainability data 110 of the product 112 throughout its lifecycle. A “Digital Thread Backbone” in the form of a DT Portal-Custom Data Client software, enables seamless data integration from pre-manufacturing to post-use of the product 112. The web-based digital thread 227 functions are developed on top of a Service Oriented Architecture (SOA) API. These APIs are designed to support fast and secure exchange of contextualized information in a bi-directional flow between the web-based digital thread 227 and its client tools. The web-based digital thread 227 is accessible by different users with various roles and functions. It supports online/offline data analysis and can be deployed to open and closed enterprise networks. The DT Portal client software can be commissioned on pc, laptop computer and mobile device. The core functionality of the web-based digital thread 227 and its operating model is depicted in FIGS. 6-7.

In FIG. 7, it illustrates a Digital Thread (DT) Framework 705 in accordance with an exemplary embodiment of the present invention. FIG. 7 depicts multi-tier enterprise framework of a Digital Thread. The architecture of a Digital Thread (DT) System includes a DT server 707 and a DT client (DT Portal) 710 and it is decomposed into three logical tiers: a Client Tier 712(1), a Business Tier 712(2) and a Data Tier 712(3). The Client Tier 712(1) hosts DT Portal clients A and B 710(1-2) that implement Service Oriented Architecture (SOA) communication with the DT server 707 using a Service Oriented Architecture (SOA) API 715. A Graphical User Interface (GUI) 717 may be used for data uploads and downloads via the SOA API 715. In this case, the SOA API 715 for web services is based on HyperText Transfer Protocol (HTTP) communication.

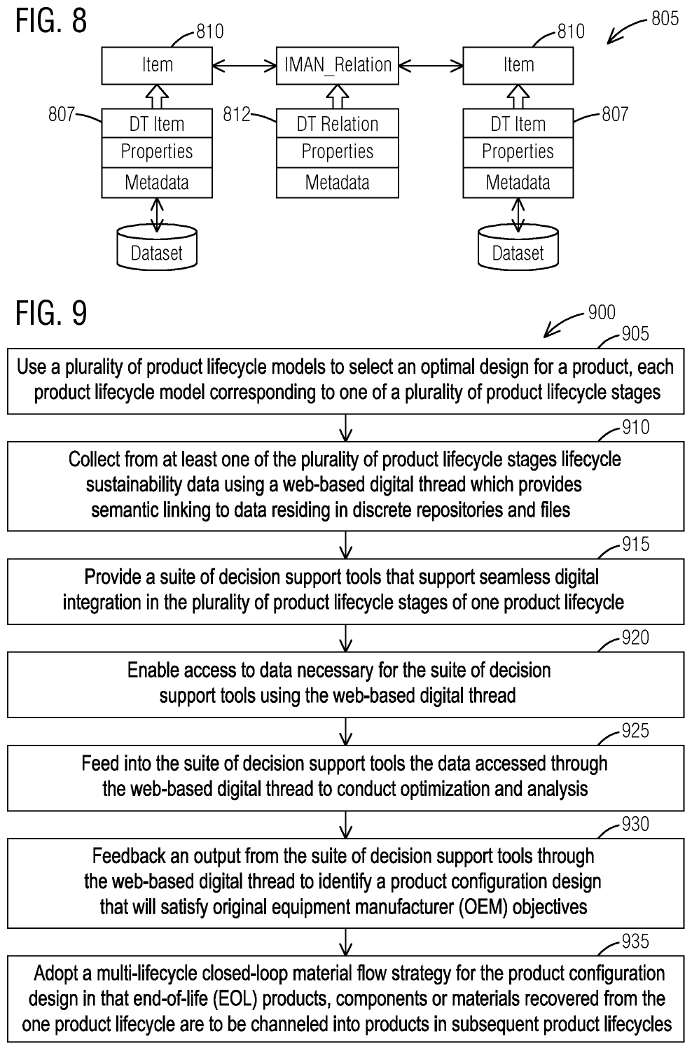

The Business Tier 712(2) hosts the DT server 707 as a web server and manages DT administrator—deployed custom data model for a Digital Thread. The model is developed offline, using a Business Modeler IDE (BM IDE) developer toolset; and later validated and deployed to the Business Tier 712(2) for secure data exchange. The Business Tier 712(2) functions on top of a core API 720. A data schema 805 including its inheritance model in BM IDE for Lifecycle Sustainability model is depicted in FIG. 8.

The deployment of a custom data model is performed using direct data transfer functionality of BM IDE. The BM IDE tool establishes a secure connection to the DT server 707 and requests a model deployment. The model is validated by the deployment manager of BM IDE and transferred to a server using HTTP communication protocol. After successful deployment of a custom data model, it is responsibility of the DT server 707 to validate the incoming and the outgoing data quality and relations between data items, based on pre-loaded custom data schema.

The core metadata schema of the model is depicted in FIG. 8. Only one custom data type: DTItem 807 is modeled to store the lifecycle sustainability data within the DT server 707. However, an item 810 is designed in a way that it can be instantiated multiple times as long as the lifecycle sustainability model is incomplete. Each instance of DTItem 807 has a logical reference (semantic relation 812) to another instance. That relation has a custom attribute defining the type of the relation and its cardinality. Thus, the model can be easily generated, altered and removed by the DT Clients, since it has minimal dependencies to other model constructs.

Referring back to FIG. 7, the Data Tier 712(3) hosts two types of data store: a file store 725—for storing DT datasets or large attachments and a SQL Server 730 for storing user data model and runtime logical relations between model elements and links to a file store. The data tier 712(3) is configured and deployed during installation. It does not require user customization but does require additional installation of a 3^{rd} party relational database. In case of the Digital Thread (DT) Framework 705, it supports SQL Server or Oracle relational databases as part of data tier installation.

A File Management System (FMS) is another component of the data tier 712(3). It is responsible for managing large footprint files that are attached to a DT data item, if required. In our case it is configured to store any files independently of a footprint. The FMS is used to store Lifecycle Sustainability Analysis (LSA) Reports and other supplemental documents that are required by the LSA use case. Also, in case of DT demonstration, the deployment of Business Tier and Data are combined and deployed to a single node (computer hosting DT server), for simplification and easy maintenance.

With respect to FIG. 9, it illustrates a schematic view of a flow chart of a computer-implemented method 900 for sustainable manufacturing via digitally-integrated, multi-lifecycle product development in accordance with an exemplary embodiment of the present invention. Reference is made to the elements and features described in FIGS. 1-8. It should be appreciated that some steps are not required to be performed in any particular order, and that some steps are optional.

The method 900 comprises a step 905 of using a plurality of product lifecycle models to select an optimal design for a product. Each product lifecycle model corresponds to one of a plurality of product lifecycle stages. The method 900 further comprises a step 910 of collecting from at least one of the plurality of product lifecycle stages lifecycle sustainability data using a web-based digital thread which provides semantic linking to data residing in discrete repositories and files. The method 900 further comprises a step 915 of using a suite of decision support tools that support seamless digital integration in the plurality of product lifecycle stages of one product lifecycle. The method 900 further comprises a step 920 of enabling access to data necessary for the suite of decision support tools using the web-based digital thread.

The method 900 further comprises a step 925 of feeding into the suite of decision support tools the data accessed through the web-based digital thread to conduct optimization and analysis. The method 900 further comprises a step 930 of feeding back an output from the suite of decision support tools through the web-based digital thread to identify a product configuration design that will satisfy original equipment manufacturer (OEM) objectives. The method 900 further comprises a step 935 of adopting a multi-lifecycle closed-loop material flow strategy for the product configuration design in that end-of-life (EOL) products, components or materials recovered from the one product lifecycle are to be channeled into products in subsequent product lifecycles.

In the method 900, the step of feeding back an output from the suite of decision support tools through the web-based digital thread further comprises considering activities across all four product lifecycle stages of the plurality of product lifecycle stages and data for all economic, environmental and societal impacts related to the four product lifecycle stages. Considering activities across all four product lifecycle stages of the plurality of product lifecycle stages further comprises considering sourcing materials to converting them to finished products as well as their consumption and end-of-life (EOL) activities. In the method 900, the step of adopting a multi-lifecycle closed-loop material flow strategy for the product configuration design further comprises considering all four product lifecycle stages of the plurality of product lifecycle stages over the duration a new product will be in market.

The method 900 further comprises providing a systematic approach for development and analysis of a lifecycle sustainability model of a designed product. The method 900 further comprises providing a central repository as a single point of access to the lifecycle sustainability data. The method 900 further comprises providing a digitally integrated multi-lifecycle product design capability using the web-based digital thread based on predictive computational modeling for multi-lifecycle product design optimization, simulation, and uncertainty and risk analysis. The method 900 further comprises considering multi-criteria decision making for sustainable product design and analysis. The method 900 further comprises providing a multi-lifecycle approach for sustainable product design and analysis. The method 900 further comprises providing an ability to identify optimal product configurations that enhance total lifecycle sustainability performance.

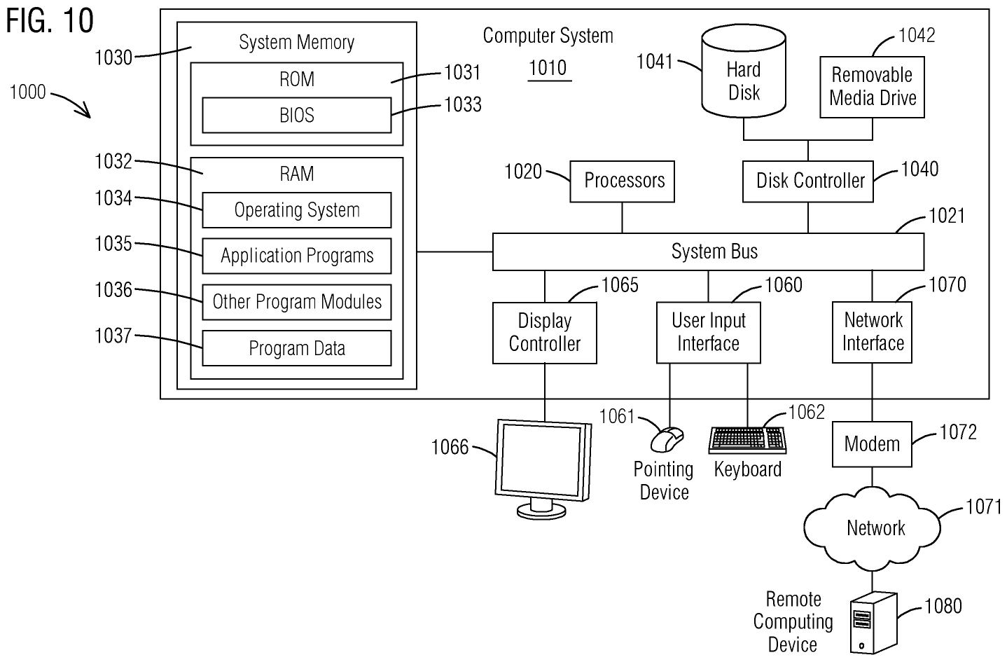

FIG. 10 shows an example of a computing environment 1000 within which embodiments of the disclosure may be implemented. For example, this computing environment 1000 may be configured to execute the digital thread discussed above with reference to FIG. 1 or to execute portions of the method 900 described above with respect to FIG. 9. Computers and computing environments, such as computer system 1010 and computing environment 1000, are known to those of skill in the art and thus are described briefly here.

As shown in FIG. 10, the computer system 1010 may include a communication mechanism such as a bus 1021 or other communication mechanism for communicating information within the computer system 1010. The computer system 1010 further includes one or more processors 1020 coupled with the bus 1021 for processing the information. The processors 1020 may include one or more central processing units (CPUs), graphical processing units (GPUs), or any other processor known in the art.

The computer system 1010 also includes a system memory 1030 coupled to the bus 1021 for storing information and instructions to be executed by processors 1020. The system memory 1030 may include computer readable storage media in the form of volatile and/or nonvolatile memory, such as read only memory (ROM) 1031 and/or random access memory (RAM) 1032. The system memory RAM 1032 may include other dynamic storage device(s) (e.g., dynamic RANI, static RANI, and synchronous DRAM). The system memory ROM 1031 may include other static storage device(s) (e.g., programmable ROM, erasable PROM, and electrically erasable PROM). In addition, the system memory 1030 may be used for storing temporary variables or other intermediate information during the execution of instructions by the processors 1020. A basic input/output system (BIOS) 1033 containing the basic routines that helps to transfer information between elements within computer system 1010, such as during start-up, may be stored in ROM 1031. RAM 1032 may contain data and/or program modules that are immediately accessible to and/or presently being operated on by the processors 1020. System memory 1030 may additionally include, for example, operating system 1034, application programs 1035, other program modules 1036 and program data 1037.

The computer system 1010 also includes a disk controller 1040 coupled to the bus 1021 to control one or more storage devices for storing information and instructions, such as a hard disk 1041 and a removable media drive 1042 (e.g., floppy disk drive, compact disc drive, tape drive, and/or solid state drive). The storage devices may be added to the computer system 1010 using an appropriate device interface (e.g., a small computer system interface (SCSI), integrated device electronics (IDE), Universal Serial Bus (USB), or FireWire).

The computer system 1010 may also include a display controller 1065 coupled to the bus 1021 to control a display 1066, such as a cathode ray tube (CRT) or liquid crystal display (LCD), for displaying information to a computer user. The computer system includes an input interface 1060 and one or more input devices, such as a keyboard 1062 and a pointing device 1061, for interacting with a computer user and providing information to the processor 1020. The pointing device 1061, for example, may be a mouse, a trackball, or a pointing stick for communicating direction information and command selections to the processor 1020 and for controlling cursor movement on the display 1066. The display 1066 may provide a touch screen interface which allows input to supplement or replace the communication of direction information and command selections by the pointing device 1061.

The computer system 1010 may perform a portion or all of the processing steps of embodiments of the invention in response to the processors 1020 executing one or more sequences of one or more instructions contained in a memory, such as the system memory 1030. Such instructions may be read into the system memory 1030 from another computer readable medium, such as a hard disk 1041 or a removable media drive 1042. The hard disk 1041 may contain one or more datastores and data files used by embodiments of the present invention. Datastore contents and data files may be encrypted to improve security. The processors 1020 may also be employed in a multi-processing arrangement to execute the one or more sequences of instructions contained in system memory 1030. In alternative embodiments, hard-wired circuitry may be used in place of or in combination with software instructions. Thus, embodiments are not limited to any specific combination of hardware circuitry and software.

As stated above, the computer system 1010 may include at least one computer readable medium or memory for holding instructions programmed according to embodiments of the invention and for containing data structures, tables, records, or other data described herein. The term “computer readable medium” as used herein refers to any medium that participates in providing instructions to the processor 1020 for execution. A computer readable medium may take many forms including, but not limited to, non-volatile media, volatile media, and transmission media. Non-limiting examples of non-volatile media include optical disks, solid state drives, magnetic disks, and magneto-optical disks, such as hard disk 1041 or removable media drive 1042. Non-limiting examples of volatile media include dynamic memory, such as system memory 1030. Non-limiting examples of transmission media include coaxial cables, copper wire, and fiber optics, including the wires that make up the bus 1021. Transmission media may also take the form of acoustic or light waves, such as those generated during radio wave and infrared data communications.

The computing environment 1000 may further include the computer system 1010 operating in a networked environment using logical connections to one or more remote computers, such as remote computer 1080. Remote computer 1080 may be a personal computer (laptop or desktop), a mobile device, a server, a router, a network PC, a peer device or other common network node, and typically includes many or all of the elements described above relative to computer system 1010. When used in a networking environment, computer system 1010 may include modem 1072 for establishing communications over a network 1071, such as the Internet. Modem 1072 may be connected to bus 1021 via user network interface 1070, or via another appropriate mechanism.

Network 1071 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 1010 and other computers (e.g., remote computer 1080). The network 1071 may be wired, wireless or a combination thereof. Wired connections may be implemented using Ethernet, Universal Serial Bus (USB), RJ-11 or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 1071.

In some embodiments, the computer system 1010 may be utilized in conjunction with a parallel processing platform comprising a plurality of processing units. This platform may allow parallel execution of one or more of the tasks associated with optimal design generation, as described above. For the example, in some embodiments, execution of multiple product lifecycle simulations may be performed in parallel, thereby allowing reduced overall processing times for optimal design selection.

The embodiments of the present disclosure may be implemented with any combination of hardware and software. In addition, the embodiments of the present disclosure may be included in an article of manufacture (e.g., one or more computer program products) having, for example, computer-readable, non-transitory media. The media has embodied therein, for instance, computer readable program code for providing and facilitating the mechanisms of the embodiments of the present disclosure. The article of manufacture can be included as part of a computer system or sold separately.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A graphical user interface (GUI), as used herein, comprises one or more display images, generated by a display processor and enabling user interaction with a processor or other device and associated data acquisition and processing functions. The GUI also includes an executable procedure or executable application. The executable procedure or executable application conditions the display processor to generate signals representing the GUI display images. These signals are supplied to a display device which displays the image for viewing by the user. The processor, under control of an executable procedure or executable application, manipulates the GUI display images in response to signals received from the input devices. In this way, the user may interact with the display image using the input devices, enabling user interaction with the processor or other device.

The functions and process steps herein may be performed automatically or wholly or partially in response to user command. An activity (including a step) performed automatically is performed in response to one or more executable instructions or device operation without user direct initiation of the activity.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers and processes can be implemented using hardware components, software components, and/or combinations thereof.

Computer readable medium instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, may be implemented by computer readable medium instructions.

It should be appreciated that the program modules, applications, computer-executable instructions, code, or the like depicted in FIG. 10 as being stored in the system memory are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the computer system 1010, the remote device, and/or hosted on other computing device(s) accessible via one or more of the network(s), may be provided to support functionality provided by the program modules, applications, or computer-executable code depicted in FIG. 10 and/or additional or alternate functionality. Further, functionality may be modularized differently such that processing described as being supported collectively by the collection of program modules depicted in FIG. 10 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 10 may be implemented, at least partially, in hardware and/or firmware across any number of devices.

It should further be appreciated that the computer system 1010 may include alternate and/or additional hardware, software, or firmware components beyond those described or depicted without departing from the scope of the disclosure. More particularly, it should be appreciated that software, firmware, or hardware components depicted as forming part of the computer system 1010 are merely illustrative and that some components may not be present or additional components may be provided in various embodiments. While various illustrative program modules have been depicted and described as software modules stored in system memory, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like can be additionally based on one or more other operations, elements, components, data, or the like. Accordingly, the phrase “based on,” or variants thereof, should be interpreted as “based at least in part on.”

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While four product lifecycle stages are described here a range of one or more other number/types of product lifecycle stages or other forms of product lifecycle stages are also contemplated by the present invention. For example, other types of product lifecycle stages may be implemented based on one or more features presented above without deviating from the spirit of the present invention.

The techniques described herein can be particularly useful for lifecycle sustainability data. While particular embodiments are described in terms of the lifecycle sustainability data, the techniques described herein are not limited to lifecycle sustainability data but can also be used with other lifecycle data.

While embodiments of the present invention have been disclosed in exemplary forms, it will be apparent to those skilled in the art that many modifications, additions, and deletions can be made therein without departing from the spirit and scope of the invention and its equivalents, as set forth in the following claims.

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure embodiments in detail. It should be understood, however, that the detailed description and the specific examples, while indicating preferred embodiments, are given by way of illustration only and not by way of limitation. Various substitutions, modifications, additions and/or rearrangements within the spirit and/or scope of the underlying inventive concept will become apparent to those skilled in the art from this disclosure.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited to only those elements but may include other elements not expressly listed or inherent to such process, article, or apparatus.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms.

In the foregoing specification, the invention has been described with reference to specific embodiments. However, one of ordinary skill in the art appreciates that various modifications and changes can be made without departing from the scope of the invention. Accordingly, the specification and figures are to be regarded in an illustrative rather than a restrictive sense, and all such modifications are intended to be included within the scope of invention.

Although the invention has been described with respect to specific embodiments thereof, these embodiments are merely illustrative, and not restrictive of the invention. The description herein of illustrated embodiments of the invention is not intended to be exhaustive or to limit the invention to the precise forms disclosed herein (and in particular, the inclusion of any particular embodiment, feature or function is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Respective appearances of the phrases “in one embodiment,” “in an embodiment,” or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

It will also be appreciated that one or more of the elements depicted in the drawings/figures can also be implemented in a more separated or integrated manner, or even removed or rendered as inoperable in certain cases, as is useful in accordance with a particular application.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

What is claimed is:

1. A computer-implemented method for sustainable manufacturing via digitally-integrated, multi-lifecycle product development, the method comprising:
using a plurality of product lifecycle models to select an optimal design for a product, each product lifecycle model corresponding to one of a plurality of product lifecycle stages;
collecting from at least one of the plurality of product lifecycle stages lifecycle sustainability data using a web-based digital thread which provides semantic linking to data residing in discrete repositories and files;
using a suite of decision support tools that support seamless digital integration in the plurality of product lifecycle stages of one product lifecycle;
enabling access to data necessary for the suite of decision support tools using the web-based digital thread;
feeding into the suite of decision support tools the data accessed through the web-based digital thread to conduct optimization and analysis;
feeding back an output from the suite of decision support tools through the web-based digital thread to identify a product configuration design that will satisfy original equipment manufacturer (OEM) objectives; and
adopting a multi-lifecycle closed-loop material flow strategy for the product configuration design in that end-of-life (EOL) products, components or materials recovered from the one product lifecycle are to be channeled into products in subsequent product lifecycles.

2. The method of claim 1, wherein feeding back an output from the suite of decision support tools through the web-based digital thread further comprising:
providing at least four product lifecycle stages of the plurality of product lifecycle stages; and
considering activities across all four product lifecycle stages of the plurality of product lifecycle stages and data for all economic, environmental and societal impacts related to the four product lifecycle stages.

3. The method of claim 2, wherein considering activities across all four product lifecycle stages of the plurality of product lifecycle stages further comprising:
considering sourcing materials to converting them to finished products as well as their consumption and end-of-life (EOL) activities.

4. The method of claim 1, wherein adopting a multi-lifecycle closed-loop material flow strategy for the product configuration design further comprising:
providing at least four product lifecycle stages of the plurality of product lifecycle stages; and
considering all four product lifecycle stages of the plurality of product lifecycle stages over the duration a new product will be in market.

5. The method of claim 1, further comprising:
providing a systematic approach for development and analysis of a lifecycle sustainability model of a designed product.

6. The method of claim 1, further comprising:
providing a central repository as a single point of access to the lifecycle sustainability data.

7. The method of claim 1, further comprising:
providing an ability to identify optimal product configurations that enhance total lifecycle sustainability performance.

8. A data processing system for generating an optimal design of a product based on a data-feedback loop from product lifecycle into design and manufacturing information, the system comprising:
a software interface configured to receive measured product lifecycle datasets uploaded by one or more stakeholders during each of a plurality of product lifecycle stages;
a database configured to store the measured product lifecycle datasets uploaded via the software interface;
one or more processors; and
an accessible memory storing a digitally integrated total lifecycle product designer comprising software instructions that when executed by the one or more processors are configured to:
use a plurality of product lifecycle models to select an optimal design for a product, each product lifecycle model corresponding to one of the plurality of product lifecycle stages;
collect from at least one of the plurality of product lifecycle stages lifecycle sustainability data using a web-based digital thread which provides semantic linking to data residing in discrete repositories and files;
use a suite of decision support tools that support seamless digital integration in the plurality of product lifecycle stages of one product lifecycle;
enable access to data necessary for the suite of decision support tools using the web-based digital thread;
feed into the suite of decision support tools the data accessed through the web-based digital thread to conduct optimization and analysis;
feedback an output from the suite of decision support tools through the web-based digital thread to identify a product configuration design that will satisfy original equipment manufacturer (OEM) objectives; and
adopt a multi-lifecycle closed-loop material flow strategy for the product configuration design in that end-of-life (EOL) products, components or materials recovered from the one product lifecycle are to be channeled into products in subsequent product lifecycles.

9. The system of claim 8, wherein the software interface is further configured to facilitate downloading of the measured product lifecycle datasets stored in the database by the one or more stakeholders.

10. The system of claim 8, wherein feeding back an output from the suite of decision support tools through the web-based digital thread further comprising:
providing at least four product lifecycle stages of the plurality of product lifecycle stages; and
considering activities across all four product lifecycle stages of the plurality of product lifecycle stages and data for all economic, environmental and societal impacts related to the four product lifecycle stages.

11. The system of claim 10, wherein considering activities across all four product lifecycle stages of the plurality of product lifecycle stages further comprising:
considering sourcing materials to converting them to finished products as well as their consumption and end-of-life (EOL) activities.

12. The system of claim 8, wherein adopting a multi-lifecycle closed-loop material flow strategy for the product configuration design further comprising:
providing at least four product lifecycle stages of the plurality of product lifecycle stages; and
considering all four product lifecycle stages of the plurality of product lifecycle stages over the duration a new product will be in market.

13. A non-transitory computer-readable medium encoded with executable instructions that, when executed, cause one or more data processing systems to:
use a plurality of product lifecycle models to select an optimal design for a product, each product lifecycle model corresponding to one of the plurality of product lifecycle stages;
collect from at least one of the plurality of product lifecycle stages lifecycle sustainability data using a web-based digital thread which provides semantic linking to data residing in discrete repositories and files;
use a suite of decision support tools that support seamless digital integration in the plurality of product lifecycle stages of one product lifecycle;
enable access to data necessary for the suite of decision support tools using the web-based digital thread;
feed into the suite of decision support tools the data accessed through the web-based digital thread to conduct optimization and analysis;
feedback an output from the suite of decision support tools through the web-based digital thread to identify a product configuration design that will satisfy original equipment manufacturer (OEM) objectives; and
adopt a multi-lifecycle closed-loop material flow strategy for the product configuration design in that end-of-life (EOL) products, components or materials recovered from the one product lifecycle are to be channeled into products in subsequent product lifecycles.

14. The computer-readable medium of claim 13, wherein feeding back an output from the suite of decision support tools through the web-based digital thread further comprising:
providing at least four product lifecycle stages of the plurality of product lifecycle stages; and
considering activities across all four product lifecycle stages of the plurality of product lifecycle stages and data for all economic, environmental and societal impacts related to the four product lifecycle stages.

15. The computer-readable medium of claim 14, wherein considering activities across all four product lifecycle stages of the plurality of product lifecycle stages further comprising:
considering sourcing materials to converting them to finished products as well as their consumption and end-of-life (EOL) activities.

16. The computer-readable medium of claim 13, wherein adopting a multi-lifecycle closed-loop material flow strategy for the product configuration design further comprising:
providing at least four product lifecycle stages of the plurality of product lifecycle stages; and
considering all four product lifecycle stages of the plurality of product lifecycle stages over the duration a new product will be in market.

17. The computer-readable medium of claim 13, wherein executable instructions that, when executed, cause one or more data processing systems to:
provide a digitally integrated total lifecycle product design capability using the web-based digital thread that support tools for computational modeling for multi-lifecycle product design optimization, simulation, and uncertainty and risk analysis.
